(19) United States
(12) Patent Application Publication
(10) Pub. No.: US 2006/0206422 A1
(43) Pub. Date: Sep. 14, 2006

(54) Method and system for determining and providing communications service based on a customer request

(76) Inventor: Alex Mashinsky, Memphis, TN (US)

Correspondence Address: MORGAN & FINNEGAN, L.L.P., 3 WORLD FINANCIAL CENTER, NEW YORK, NY, 10281-2101, US

(21) Appl. No.: 10/485,783

(22) PCT Filed: Jul. 30, 2002
(86) PCT No.: PCT/US02/24249

§ 371 Date: Oct. 28, 2004

Related U.S. Application Data
(60) Provisional application No. 60/308,638, filed on Jul. 30, 2001.

(51) Int. Cl. G06Q 40/00

(52) U.S. Cl. 705/40

(57) ABSTRACT

According to the present invention, a customer transmits a request for service to a Service Comparison/Acquisition Provider (SCAP). The request defines parameters related to the service, such as the type of device to be used, the address of the device to be communicated with, the duration of communication, an access method and a method of payment. Based in part on the parameters specified by the customer in a service request, the SCAP determines a price for which the SCAP can provide the customer with the requested service. The SCAP then transmits the price to the customer. If the customer agrees to the purchase, then the SCAP provides the customer with the requested service. The SCAP is capable of identifying the networks and elements necessary to enable users to download requested services. Further, the SCAP is capable of inquiring and reserving capacity for optimizing the download of requested services.

### RELATED APPLICATION

The instant application claims priority to U.S. Provisional Application Ser. No. 60/308,638, filed Jul. 30, 2001, and is herein incorporated by reference.

### FIELD OF THE INVENTION

The present invention is directed to a method and system for determining and providing communication service based on a customer request.

### BACKGROUND OF THE INVENTION

Current technologies and services offered by communication companies offer consumers a great variety of choices for deciding how to communicate information. Several examples of communication systems include but are not limited to: POTS, VoIP, Callback, Toll-free phone calls, Wireless phone systems, SMS, WAP, DSL, Wireless Networks, Cable, Broadband, and Video.

Each communication company may utilize a different specific pricing structure, thereby making it extremely difficult for consumers to determine which company and technology is most cost effective for their needs.

Further, most communications companies provide only a few of these services and are unable to provide the remaining services to their customers. As such, there is currently no system which offers consumers real-time quotes for a variety of available telecommunications services, and further has the capability to provision the services to the consumers.

### SUMMARY

Disclosed in the instant application is a method and system for providing telecommunications services and/or the like, to a customer based on a number of customer defined request parameters.

According to the present invention, a customer transmits a request for communications service to a Service Comparison/Acquisition Provider (SCAP). The request defines a number of parameters related to the service, such as the type of communication device to be used, the address of the device to be communicated with, the duration of communication, an access method, and a method of payment. Based in part on the parameters specified by the customer in a service request, the SCAP determines a price for which the SCAP can provide the customer with the requested service. The SCAP then transmits the price to the customer. If the customer agrees to the purchase, then the SCAP provides the customer with the requested service.

For example, in one embodiment of the present invention, a customer using a Web browser may log onto a Web site maintained by the SCAP. At the Web site, the customer may submit a request for a 60-minute phone call from a pay phone in New York to a wireless phone in London. The SCAP determines that the service may be offered to the customer for $2.00. If the customer accepts, the SCAP issues the customer a phone number and a PIN number to be used to access the service. The customer may then use a pay phone in New York to call the issued phone number, enter the PIN number (e.g. using DTMF tones), and thereby receive a connection to the wireless phone in London.

In another example, the customer may use a personal computer enabled with speakers and a microphone to access VoIP service provided by the SCAP. In this example, if the customer accepts the price offered by the SCAP, a VoIP dialer may immediately launch on the customer's PC, thereby connecting the customer to, e.g., the specified London phone number.

### BRIEF DESCRIPTION OF THE FIGURES

FIG. 1 is an exemplary diagram illustrating system elements associated with a Service Comparison/Acquisition Provider (SCAP) in an embodiment of the present invention.

FIG. 2 is a system-level structure diagram illustrating the relationships between the customer, the SCAP, and a plurality of Service Providers involved in an embodiment of the present invention.

FIG. 3 is an exemplary operation diagram of a telecommunication provider in an embodiment of the present invention.

FIG. 4 is a tabular representation of a request for telecommunication service associated with the embodiment illustrated in FIG. 3.

FIG. 5 is an exemplary operation diagram of an internet service provider in an embodiment of the present invention.

FIG. 6 is a tabular representation of a request for internet service associated with the embodiment illustrated in FIG. 5.

FIG. 7 is a diagram illustrating the relationships between the requesting entity, the SCAP, and Service Providers involved in a media content provider embodiment of the present invention.

FIG. 8 is an exemplary operation diagram of a media content provider in an embodiment of the present invention.

FIG. 9 is a tabular representation of a selection for media content associated with the embodiment illustrated in FIG. 8.

### DETAILED DESCRIPTION OF VARIOUS EMBODIMENTS OF THE PRESENT INVENTION

Service Comparison/Acquisition Provider (SCAP)

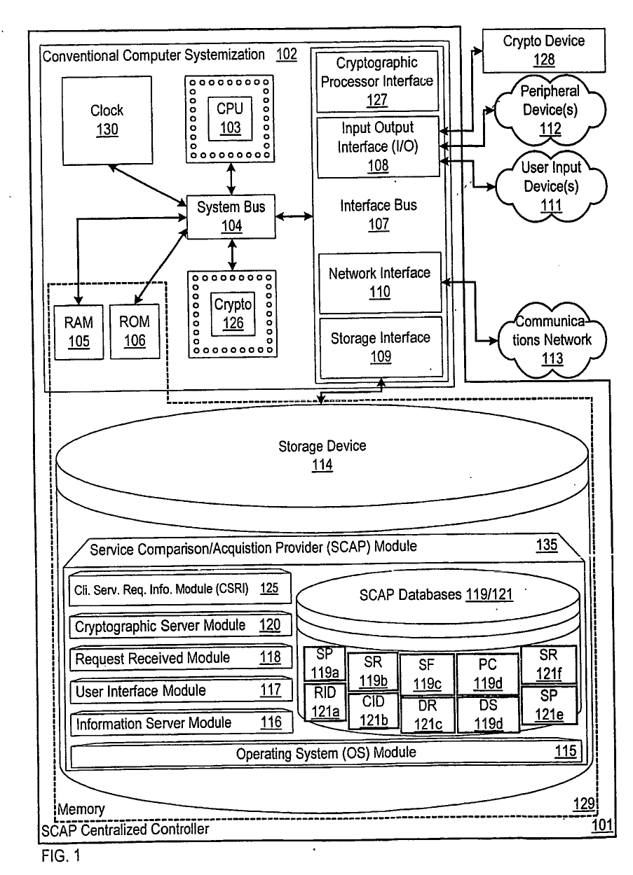

FIG. 1 is an exemplary diagram illustrating system elements associated with a Service Comparison/Acquisition Provider (SCAP) in an embodiment of the present invention. In this embodiment, the SCAP controller 101 may serve to receive, process, store, compare requests for different types of service from a user.

In one embodiment, the SCAP controller 101 may be connected to and/or communicate with entities such as, but not limited to: one or more users from user input devices 111; peripheral devices 112; and/or a communications network 113. The SCAP controller 101 may even be connected to and/or communicate with a cryptographic processor device 128.

A typical SCAP controller 101 may be based on common computer systems that may comprise, but are not limited to, components such as: a computer systemization 102 connected to memory 129.

Computer Systemization

A computer systemization 102 may comprise a clock 130, central processing unit (CPU) 103, a read only memory (ROM), a random access memory (RAM), and/or an interface bus 107, and conventionally, although not necessarily, are all interconnected and/or communicating through a system bus 104. The system clock typically has a crystal oscillator and provides a base signal. The clock is typically coupled to the system bus and various means that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Optionally, a cryptographic processor 126 may similarly be connected to the system bus. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as the Intel Pentium Processor and/or the like. The CPU interacts with memory through signal passing through conductive conduits to execute stored program code according to conventional data processing techniques. Such signal passing facilitates communication within the SCAP controller and beyond through various interfaces.

Interface Adapters

Interface bus(ses) 107 may accept, connect, and/or communicate to a number of interface adapters, conventionally although not necessarily in the form of adapter cards, such as but not limited to: input output interfaces (I/O) 108, storage interfaces 109, network interfaces 110, and/or the like. Optionally, cryptographic processor interfaces 127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (PCI), Personal Computer Memory Card International Association (PCMCIA), and/or the like.

Storage interfaces 109 may accept, communicate, and/or connect to a number of storage devices such as, but not limited to: storage devices 114, removable disc devices, and/or the like. Storage interfaces may employ connection protocols such as, but not limited to: (Ultra) Advanced Technology Attachment (Packet Interface) ((Ultra) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 110 may accept, communicate, and/or connect to a communications network 113. Network interfaces may employ connection protocols such as, but not limited to: direct connect, Ethernet (thick, thin, twisted pair 10/100/1000 Base T, and/or the like), Token Ring, wireless connection such as IEEE 802.11b, and/or the like. A communications network may be any one and/or the combination of the following: a direct interconnection; the Internet; a Local Area Network (LAN); Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface.

Input Output interfaces (I/O) 108 may accept, communicate, and/or connect to user input devices 111, peripheral devices 112, cryptographic processor devices 128, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394; infrared; joystick; keyboard; midi; optical; PC AT; PS/2; parallel; radio; serial; USB; video interface: BNC, composite, digital, RCA, S-Video, VGA, and/or the like; wireless; and/or the like. A common output device is a video display, which typically comprises a CRT or LCD based monitor with an interface (e.g., VGA circuitry and cable) that accepts signals from a video interface. The video interface composites information generated by a computer systemization and generates video signals based on the composited information. Typically, the video interface provides the composited video information through a video connection interface that accepts a video display interface (e.g., a VGA connector accepting a VGA display cable).

User input devices 111 may be card readers, dongles, finger print readers, gloves, graphics pads, joysticks, keyboards, mouse (mice), trackballs, trackpads, retina readers, and/or the like.

Peripheral devices 112 may be connected and/or communicate with or to I/O and/or with or to other facilities of the like such as network interfaces, storage interfaces, and/or the like). Peripheral devices may be cameras, dongles (for copy protection, ensuring secure transactions as a digital signature, and/or the like), external processors (for added functionality), goggles, microphones, monitors, network interfaces, printers, scanners, storage devices, visors, and/or the like.

Cryptographic units such as, but not limited to, microcontrollers, processors 126, interfaces 127, and/or devices 128 may be attached, and/or communicate with the SCAP controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 284.

Memory

A storage device 114 may be any conventional computer system storage. Storage devices may be a fixed hard disk drive, and/or other devices of the like. However, it is to be understood that a SCAP controller and/or a computer systemization may employ various forms of memory 129. For example, a computer systemization may be configured wherein the functionality of on-chip CPU memory (e.g., registers), RAM, ROM, and any other storage devices are provided by a paper punch tape or paper punch card mechanism; of course such an embodiment is not preferred and would result in an extremely slow rate of operation. In a typical configuration, memory 129 will include ROM, RAM, and a storage device 114. Generally, any mechanization and/or embodiment allowing a processor to affect the storage and/or retrieval of information is regarded as memory 129. Thus, a computer systemization generally requires and makes use of memory. However, memory is a fungible technology and resource, thus, any number of memory embodiments may be employed in lieu of or in concert with one another.

Module Collection

The storage devices 114 may contain a collection of program and/or database modules and/or data such as, but not limited to: an operating system module 115 (operating system); an information server module 116 (information server); a user interface module 117 (user interface); a request received module 118 (web browser); databases 119; a cryptographic server module 120 (cryptographic server); Client Service Request Information module 125; and/or the like (i.e., collectively a module collection). These modules may be stored and accessed from the storage devices and/or from storage devices accessible through an interface bus. Although non-conventional software modules such as those in the module collection, typically and preferably, are stored in a local storage device 114, they may also be loaded and/or stored in memory such as: peripheral devices, RAM, remote storage facilities through a communications network, ROM, various forms of memory, and/or the like.

Operating System

The operating system module 115 is executable program code facilitating the operation of a SCAP controller. Typically, the operating system facilitates access of I/O, network interfaces, peripheral devices, storage devices, and/or the like. The operating system preferably is a conventional product such as Apple Macintosh OS X Server, AT&T Plan 9, Microsoft Windows NT Server, Unix, and/or the like operating systems. Preferably, the operating system is highly fault tolerant, scalable, and secure. An operating system may communicate to and/or with other modules in a module collection, including itself, and/or facilities of the like. Conventionally, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. Preferably, the operating system provides communications protocols that allow the SCAP controller to communicate with other entities through a communications network 113. Various communication protocols may be used by the SCAP controller during interactions with Service Providers, such as, but not limited to: multicast, TCP/IP, UDP, unicast, and/or the like.

Information Server

An information server module 116 is stored program code that is executed by the CPU. The information server may be a conventional Internet information server such as, but not limited to, Microsoft's Internet Information Server and/or the Apache Software Foundation's Apache. Preferably, the information server allows for the execution of program modules through facilities such as C++, Java, JavaScript, ActiveX, Common Gateway Interface (CGI) scripts, Active Server Page (ASP), and/or the like. Preferably the information server supports secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. Conventionally, an information server provides results in the form of web pages to web browsers, and allows for the manipulated generation of the web pages through interaction with other program modules. After a DNS resolution portion of an HTTP request is resolved to a particular information server, the information server resolves requests for information at specified locations on a SCAP controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” An information server may communicate to and/or with other modules in a module collection, including itself, and/or facilities of the like. Most frequently, the information server communicates with operating systems, other program modules, user interfaces, web browsers, and/or the like. An information server may contain, communicate, generate, obtain, and/or provide program module, system, user, and/or data communications, requests, and/or responses.

User Interface

A user interface module 117 is stored program code that is executed by the CPU. Preferably, the user interface is a conventional graphic user interface as provided by, with, and/or atop operating systems and/or operating environments such as Apple Macintosh OS, e.g., Aqua, Microsoft Windows (NT), Unix X Windows (KDE, Gnome, and/or the like), and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Request Received

A request received module 118 is stored program code that is executed by the CPU. The request received module 118 receives a service request from the customer. In one embodiment of the invention, the module accepts service request data from data submitted as a web page form. The request received module 118 parses the submitted data, and extracts pertinent data for the SCAP module to execute the Service Provider comparison aspect of the instant invention. Further, the request received module 118 may be any type of message, e-mail, automated information extraction service. Alternately, the request received module 118 may be stored program code that is executed to manage a program utilized by a telephone operator, manually inputting the service request information.

SCAP Databases

Two SCAP database modules are illustrated in FIG. 1, 119 and 121, respectively. The databases may be embodied in a database that is stored program code and executed by the CPU. The stored program code portion configures the CPU to process the data stored in the database. Preferably, the databases are conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the SCAP databases may be implemented using various standard data-structures, such as an array, hash, (linked) list, struct, table, and/or the like. Such data-structures may be stored in memory and/or in (structured) files. If the SCAP databases are implemented as data-structures, the use of the SCAP databases may be integrated into another module such as the SCAP module. Databases may be consolidated and/or distributed in countless variations through standard data processing techniques. Portions of databases, e.g., tables, may be exported and/or imported and thus decentralized and/or integrated. In one non-limiting example embodiment, the database module 119 includes tables such as, but not limited to, SP table 119a (a listing of Service Providers), SR table 119b (a listing of Services Renderable associated with the various Service Providers), Service fee tables 119c, a previous client table 119d, and/or the like. The database module 121 includes tables such as but not limited to a request ID 121a, client ID 121b, a time associated with the submission of the service request 122c, a time associated with service provision 122d, the associated Service Provider 122e, and the service rate 122f, and/or the like. All the tables may be related by a service request ID which is specific to a particular customer's individual service request.

In an alternative embodiment, these tables are capable of being decentralized into their own databases and their respective database controllers (i.e., individual database controllers for each of the above tables). Of course, employing standard data processing techniques, one may further distribute the databases over several computer systemizations and/or storage devices. Similarly, configurations of the decentralized database controllers may be varied by consolidating and/or distributing the various database modules 119a-d and 121a-f.

SCAP databases may communicate to and/or with other modules in a module collection, including themselves, and/or facilities of the like. Most frequently, the SCAP databases communicate with a SCAP module, other program modules, and/or the like. The databases may contain, retain, and provide information regarding other nodes and data.

Cryptographic Server

A cryptographic server module 120 is stored program code that is executed by the CPU 103, cryptographic processor 126, cryptographic processor interface 127, cryptographic processor device 128, and/or the like. Preferably, cryptographic processor interfaces will allow for expedition of encryption and/or decryption requests by the cryptographic module; however, the cryptographic module, alternatively, may run on a conventional CPU. Preferably, the cryptographic module allows for the encryption and/or decryption of provided data. Preferably, the cryptographic module allows for both symmetric and asymmetric (e.g., Pretty Good Protection (PGP)) encryption and/or decryption. Preferably, the cryptographic module allows conventional cryptographic techniques such as, but not limited to: digital certificates (e.g., X.509 authentication framework), digital signatures, dual signatures, enveloping, password access protection, public key management, and/or the like. Preferably, the cryptographic module will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, RC5 (Rivest Cipher), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. The cryptographic module facilitates the process of “security authorization” whereby access to a resource is inhibited by a security protocol wherein the cryptographic module effects authorized access to the secured resource. A cryptographic module may communicate to and/or with other modules in a module collection, including itself, and/or facilities of the like. Preferably, the cryptographic module supports encryption schemes allowing for the secure transmission of information across a communications network to enable a SCAP module to engage in secure transactions if so desired by users. The cryptographic module facilitates the secure accessing of resources on SCAP and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

Service Comparison/Acquisition Provider (SCAP)

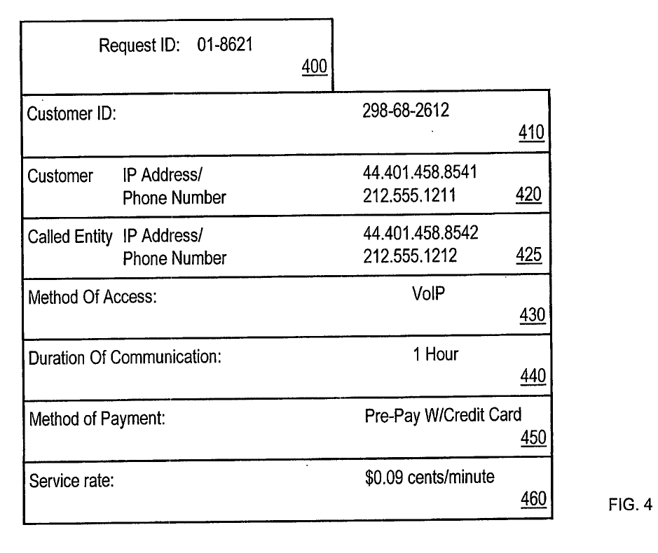

SCAP module 135 is stored program code that is executed by the CPU. Generally, the SCAP registers a service request (i.e. FIG. 4) and searches available resources to determine if a Service Provider is offering the services corresponding to the service request. Based on its findings, the SCAP prepares a service proposal in response to the customer relaying a cost estimate for the requested service. Upon receipt of a response from the requesting entity indicating acceptance of the service proposal, the SCAP coordinates the transfer of requested service from the Service Provider to the customer. The SCAP module interacts with the SCAP database. SCAP enabling processing of service requests may be developed by employing standard development tools such as, but not limited to: C++, shell scripts, Java, Javascript, SQL commands, web application server extensions, Apache modules, Perl scripts, binary executables, and/or the like. In one non-limiting example embodiment, the SCAP employs a cryptographic server to encrypt and decrypt communications. The SCAP may catalog content, service requests, service proposals, previously rendered services and their corresponding cost structures, and much more. A SCAP module may communicate to and/or with other modules in a module collection, including itself, and/or facilities of the like. The SCAP may implement UNI/NNI as a protocol manager for directing communications between different systems connected to the SCAP. It is to be understood that other standards may be implemented for the protocol manager. Generally, the SCAP module communicates internally, with customers, and with Service Providers across a communications network with: a SCAP database, an CSRI module, operating systems, other program modules, and/or the like. The SCAP may contain, communicate, generate, obtain, and/or provide program module, system, user, and/or data communications, requests, and/or responses.

Distributed SCAP

The functionality of any of the SCAP controller components and/or functionalities may be combined, consolidated, and/or distributed in any number of ways to facilitate development and/or deployment. Similarly, the module collection may be combined in any number of ways to facilitate deployment and/or development. To accomplish this, one must simply integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load balancing data processing techniques. Furthermore, single instances may also be distributed across multiple controllers and/or storage devices; e.g., databases.

All program module instances and controllers working in concert may do so through standard data processing communication techniques.

The preferred SCAP controller configuration will depend on the context of system deployment. Factors such as, but not limited to, the capacity and/or location of the underlying hardware resources may affect deployment requirements and configuration. Regardless of if the configuration results in more consolidated and/or integrated program modules, results in a more distributed series of program modules, and/or results in some combination between a consolidated and/or distributed configuration, communication of data may be communicated, obtained, and/or provided. Instances of modules (from the module collection) consolidated into a common code base from the program module collection may communicate, obtain, and/or provide data. This may be accomplished through standard data processing techniques such as, but not limited to: data referencing (e.g., pointers), internal messaging, object instance variable communication, shared memory space, variable passing, and/or the like (intra-application communication).

If module collection components are discrete, separate, and/or external to one another, then communicating, obtaining, and/or providing data with and/or to other module components may be accomplished through standard data processing techniques such as, but not limited to: Application Program Interfaces (API) information passage; (distributed) Component Object Model ((D)COM), (Distributed) Object Linking And Embedding ((D)OLE), and/or the like), Common Object Request Broker Architecture (CORBA), process pipes, shared files, and/or the like (inter-application communication). Messages sent between discrete module components for inter-application communication or within memory spaces of a singular module for intra-application communication may be facilitated through the creation and parsing of a grammar. A grammar may be developed by using standard development tools such as lex, yacc, and/or the like, which allow for grammar generation and parsing functionality, which in turn may form the basis of communication messages within and between modules. Again, the preferable embodiment will depend upon the context of system deployment.

Client Service Request Information (CSRI)

An CSRI module 125 is stored program code that is executed by the CPU. Generally, the CSRI module affects accessing, obtaining and storing information related to outstanding service requests that have been processed. The module may be used to analyze a specific customer's service request history, services rendered to a particular customer. Further, the CSRI module provides a system user greater access to the SCAP database 121 by working in coordination with the database and a system user.

Finally, it is to be understood that the logical and/or topological structure of any combination of the module collection and/or the present invention as described in the figures and throughout are not limited to a fixed execution order and/or arrangement, but rather, any disclosed order is exemplary and all functional equivalents, regardless of order, are contemplated by the disclosure. Furthermore, it is to be understood that such structures are not limited to serial execution, but rather, any number of threads, processes, services, servers, and/or the like that may execute asynchronously, simultaneously, synchronously, and/or the like are contemplated by the disclosure.

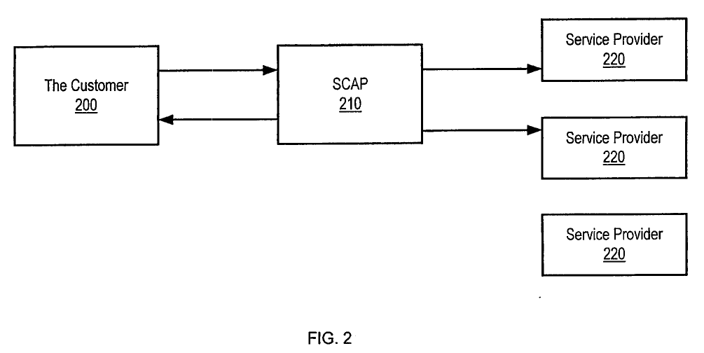

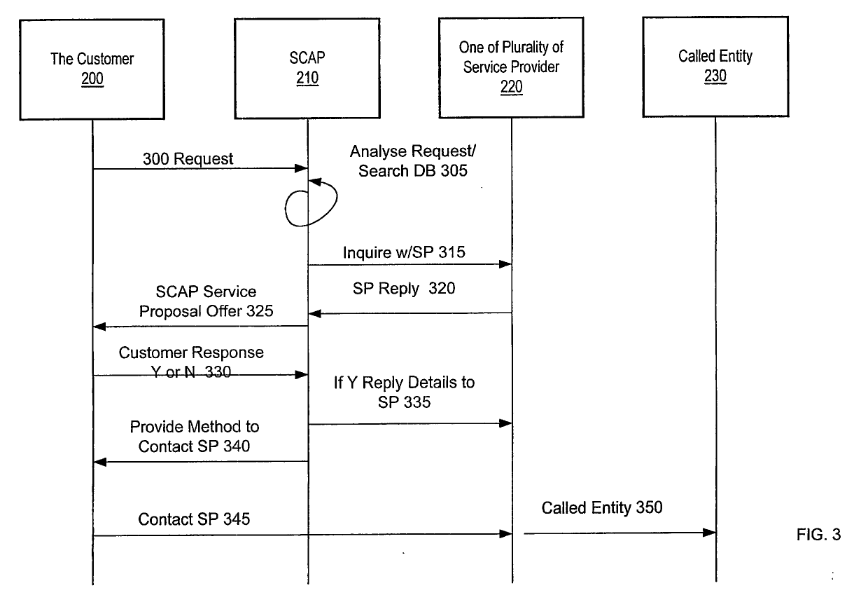

FIG. 2 is a system-level structure diagram illustrating the relationships between the customer, the SCAP, and Service Providers involved in an embodiment of the present invention. The operating details of an embodiment of the instant invention will be discussed in greater detail in FIG. 3. In FIG. 2 reference numeral 100 refers to a Requesting Entity (customer), which submits a service request to the Service Comparison/Acquisition Provider (SCAP) 110. The SCAP 210 receives the service request and searches the database 119 for a Service Provider 220 that is capable of fulfilling the service request. In one embodiment of the invention, after identifying a prospective Service Provider, the SCAP 210 contacts the Service Provider 220 and (1) verifies that the Service Provider 220 is capable of fulfilling the service request and (2) obtains a cost estimate corresponding to the service request. Alternately, the SCAP 210 may rely solely on the information contained in the SCAP database 119 to supply the data for the preparing the service proposal to the customer 200. In yet another embodiment, the SCAP 210 may be in communication with a database maintained by industry Service Providers 220, themselves. Once the Service Provider 220 and service rate are established, the SCAP 210 prepares and transmits an offer to provide the requested services to the customer 200. The customer 200 may accept or decline the offer. In the event that the customer 200 accepts the offer, Service Provider 220 provides the requested service. If the customer declines the offer, SCAP 210 may present the customer 200 with alternate Service Providers 220, an opportunity to refine the parameters associated with the service request and/or the like.

FIG. 3 is an exemplary operation diagram of a telecommunication provider in an embodiment of the present invention. The customer 200 identifies a particular need for a type of telecommunication service and prepares a request associated with a specific customer's device. The customer device may be a landline phone, a payphone, a wireless phone/device, a PC, although it is to be understood that other customer devices may be used.

The step after identification of a service need involves submitting a request for service 300 to the SCAP system 210. The customer 200 may transmit a request to SCAP 210 in a number of ways. In the embodiment illustrated in FIG. 3, the customer 200, uses a device, which the service request is corresponds to, to transmit the request to the SCAP 210 in step 300. Note that in some embodiments, the device used by the customer 200 to submit a service request and the customer device that is to be utilized for the requested service may be different. For example, the customer 200 may submit a request using a personal computer connected to the internet for telecommunications service to be used with a wireless phone.

In another example, the customer 200 may place a phone call to the SCAP 210 using devices such as a regular landline phone or a wireless phone. Information related to the request may then be transmitted over the phone. By way of example only, an operator may record the information, or the customer may interact with an IVRU. It is to be understood that other devices may be used. In yet another example, the customer 200 may send the request as a Short Message Service (SMS) or Wireless Application Protocol (WAP) data transmission.

Upon receipt of the service request from the customer 200, the SCAP utilizes the request received module 118, discussed in the description of FIG. 1 to identify parameters designated by the customer 200 in the service request 305. A description of parameters utilized in a service request follows below in the description of FIG. 4. Some of these parameters may be explicitly included in the request itself (e.g. called entity address), while others may be determined using analysis methods (e.g. customer device may be determined from access method, etc. . . . ).

Subsequent to analyzing the service request, the SCAP 210 performs a search in order to determine if there are any viable matches between the Service Providers 220 and the parameters extracted from the service request in step 305. Upon identifying a viable Service Provider 220, SCAP 210 determines an estimated service rate corresponding to the requested services by querying a number of Service Providers 220 in communication with the SCAP 210 in step 315. In some embodiments, SCAP 210 may directly query the various Service Providers 220. In other embodiments, SCAP 210 may maintain a database containing service rates for various telecommunication services offered by Service Providers 220. These service rates may be periodically updated by SCAP 210, the Service Providers 220, etc. . . .

In some embodiments of the invention, the controller may be in communication with a telecommunications exchange where a number of service providers buy and sell service to other providers (Arbinet-thexchange, Band-x, etc.). Such a telecommunications exchange may offer the most competitive prices for telecommunications service, and thus the most competitive price to offer the customer.

SCAP 210 may further consider the customer's transaction history in determining a price. For example, if the customer 200 has a history of requesting and accepting offers for overseas phone calls, SCAP 210 may increase or decrease the proposed service rate for the customer 200 depending on past experience with specific customers.

In an embodiment of the present invention SCAP 210 may determine how much it would cost the customer 200 to communicate with the specified called entity 230 using the customer's default telecommunication service and compare that cost with the price offered by the inventive system. For example, a customer 200 using a wireless phone may call the controller and submit a request for a 60-minute phone call to London using the same wireless phone. SCAP 210 may determine how much it would cost the customer 200 to place the call using the Service Provider 220 associated with the wireless phone and compare that cost with the price SCAP 210 can offer the customer 200 for providing the same service. Both prices may be sent to the customer 200 so that he or she may choose between the two services.

Upon receipt of the Service Provider's response to communication query 320, SCAP 210 may determine that it can provide the customer with the requested service from a Service Provider 220, and a service rate is determined, SCAP 210 transmits a service proposal in response to the customer's service request in step 325. The service proposal may include identifying the Service Provider 220, as well as, the price for the service and any other terms and conditions associated with accepting the service.

For example in different embodiments of the present invention, the proposal may be transmitted by one of more of the following: in an email, via a Web page, an operator employed by the company executing the SCAP 210 may call the customer 200 with the offer, an IVRU may communicate the offer, etc. The customer 200 may further respond to the service proposal (i.e. accept or reject the offer) in similar manners in step 330.

If the customer 200 accepts the offer (i.e. agrees to pay SCAP 210 the determined price for the requested telecommunications service), SCAP 210 contacts the Service Provider 220 and indicates that the service proposal has been accepted in step 335. SCAP 210 then issues commands to provision the requested service to the customer 200 or to provide the requested service to the customer 200 directly in step 340.

SCAP 210 may accomplish the transfer of service between the customer 200 and the Service Provider 220 a number of ways. For example, SCAP 210 may issue the customer 200 a phone number and a PIN (Personal Identification Number). To access the requested service, the customer 200 calls the issued phone number and enters the PIN (e.g. via DTMF, VR, etc.).

In embodiments where the customer device comprises a personal computer connected to the internet, SCAP 210 may provide the requested service by e.g. launching a VoIP application on the customer's PC. The VoIP application may provide a voice connection to the called entity identified in the request. Other methods of providing the requested service may be employed based on the type of customer device.

The customer device may be, but is not limited to a landline phone, a payphone, a wireless phone, a PC, etc. As discussed above, the customer device may be used to transmit a request to SCAP 210 and communicate with the called party, etc. Similarly, the called party's device may also represent any of these devices. Note that the customer device and the called party's device need not be the same type of communication instrument. For example, the customer device may be a PC, while the called party's 230 device may be a normal phone.

Similarly, the Service Providers 220 provide services ranging through the services offered in the telecommunication industry. Service Providers 220 may provide the customer 200 with services relating to the PSTN, the Internet, a wireless network, a private network, etc. Generally, the Service Provider's 220 telecommunications network may represent any communications network, or any combination of communications networks, that is capable of communicating information in accordance with the present invention. Note that some or all of the telecommunication network may be owned and/or operated by one or more companies.

FIG. 4 is a tabular representation of a request for telecommunication service associated with the embodiment illustrated in FIG. 3. The fields associated with a customer request may include but are not limited to the follow fields. The request ID 400 is a system defined unique identifier associated with the request, used for internal tracking purposes. The customer ID 410 is a unique identifier associated with each customer 200. The customer ID 410 may be system defined, a social security number, a credit card number or any other unique identifier useful for identifying the customer 200. The customer ID 410 may link to a customer database 119d as described in relation to FIG. 1 that stores additional information about the customer, such as payment information, transaction history with the SCAP 210, etc. The customer IP address/phone number 420 represents an address or identifier of the device to be communicated with, and may be an IP address (44.401.458.8541), or a phone number (e.g. 212.832.9595). It is also to be understood that other types of device identification may be used. The called entity IP address/phone number 425 represents an address or identifier of the device to be communicated with, and may be an IP address (44.401.458.8542), or a phone number (e.g. 212.832.9596). It is also to be understood that other types of device identification may be used. The method of access 430 indicates the means by which the customer device will access SCAP 210 when communicating with the called entity 230. For example, in one embodiment of the present invention, the customer places a local phone call, long distance phone call, or a toll free call, to SCAP 210. Alternately, the customer 200 may access SCAP 210 using an Internet Protocol connection, for example Voice over IP. Further, the request may also specify the device utilized by the called entity 230. For example, the customer 200 may use a regular landline phone, a pay phone, a wireless phone, a WAP phone, a PC, etc. to establish communications with another device in any combination thereof. The duration of communication field 440 specifies how long the customer wishes to communicate with the called entity 230. For example, the customer 200 may request to communicate for a number of minutes, hours, etc. The method of payment 450 specifies how the customer wishes to pay for the service rendered. For example, the customer 200 may select to pre-pay, use a credit card, a debit card, bill his/her phone number, have a third party pay, etc. The method of payment 450 may be relevant to determining a price because different payment options may e.g. cost SCAP 210 different amounts to process, only be available for select services, etc. Additionally, a customer 200 may request a maximum Service Rate 460 that he/she is willing to pay for the requested services.

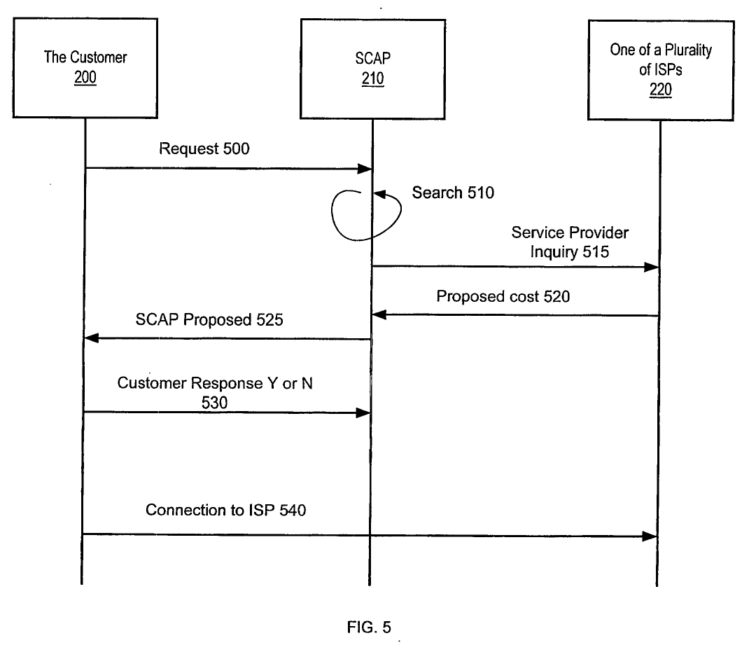

FIG. 5 is an exemplary operation diagram of an internet service provider in an embodiment of the present invention. The customer 200 identifies a particular need for a type of internet service and prepares a request associated with a specific customer's device. The customer device may be a desktop personal computer, a laptop computer, a PDA, a wireless phone that is enabled to support the internet, and/or the like.

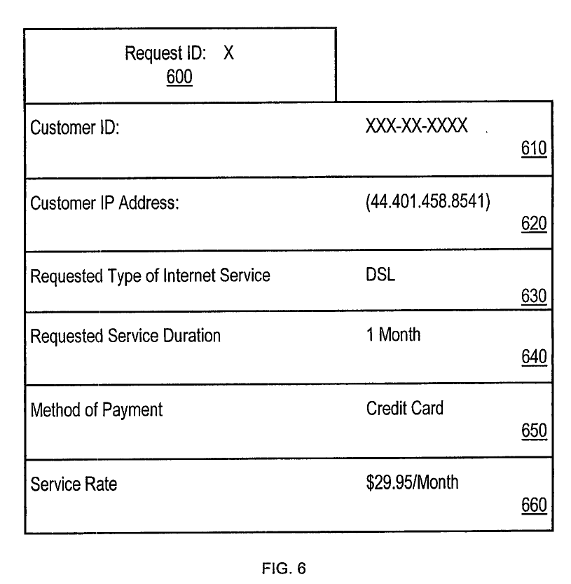

After identifying the requested services, a customer 200 submits a request for service 500 to the SCAP 210 system. The customer 200 may transmit a request to SCAP 210 in a manner similar to those detailed in the description of FIG. 3. In the embodiment illustrated in FIG. 5, the customer 200, uses a device to transmit the request to the SCAP 210 in step 500. Upon receipt from the customer the request received module 118 analyzes the service request and prepares the data associated with searching the Service Provider database in step 510. A description of parameters utilized in a service request follows below in the description of FIG. 6. Upon identifying a viable Service Provider 220, SCAP 210 determines a service rate corresponding to the requested services by querying the identified Service Provider in step 515. The Service Provider 220 transmits a response to the SCAP query indicating whether the terms associated with the service request are acceptable in step 520. Accordingly, in step 525 the SCAP 210 will transmit the service proposal to the customer 200. The customer 200, in turn, will either accept or decline the service proposal 530. In the event that the customer accepts the service proposal, the SCAP 210 transmits indication that the customer accepted the service proposal to the Service Provider 220, and establishes a means for the service transfer, in step 540.

FIG. 6 is a tabular representation of a request for internet service submitted by the customer 200 associated with in the embodiment illustrated in FIG. 5. Several of the fields in the service request are similar to those in service request in the telecommunication embodiment of the instant invention illustrated in FIG. 4. The request ID 600 is a system defined unique identifier associated with the request, used for internal tracking purposes. The customer ID 610 is a unique identifier associated with each customer. The customer ID 610 may be system defined, a social security number, a credit card number or any other unique identifier useful for identifying the customer 200. The customer ID 610 may link to a customer database 119d as described in relation to FIG. 1 that stores additional information about the customer 200, such as payment information, transaction history with the SCAP 210, etc. The customer IP address field 620 refers to the customer's device ID associated with the customer's connection to the network. The customer IP address 620 may be, but is not limited to the customer's IP address. Alternately, it is to be understood that the customer's phone number or any other type of customer device ID may be used. The requested type of internet service 630 indicates the type of internet service that the customer 200 is requesting (i.e., DSL, cable modem, dial-up services, wireless networking, and/or the like). The requested service duration field 640 specifies a length of time which the customer requests internet service. By way of example only, the customer may request service over a predetermined number of days, months, or years. The method of payment field 650 specifies how the customer 200 wishes to pay for the service rendered. For example, the customer 200 may select to pre-pay, use a credit card, a debit card, bill his/her phone number, have a third party pay, etc. The method of payment 650 may be relevant to determining a price because different payment options may e.g. cost SCAP 210 different amounts to process, only be available for select services, etc. Additionally, a customer 200 may request a maximum Service Rate 660 that he/she is willing to pay for the requested services.

In alternate embodiments of the invention, the SCAP 210 system illustrated and discussed in FIGS. 5 and 6, generally processing service requests associated with providing Internet Service, could readily be modified to process service requests from Wireless Service Providers, Cable Television Providers, Satellite Television Providers, Utilities such as Natural Gas/Electric Providers, and/or the like.

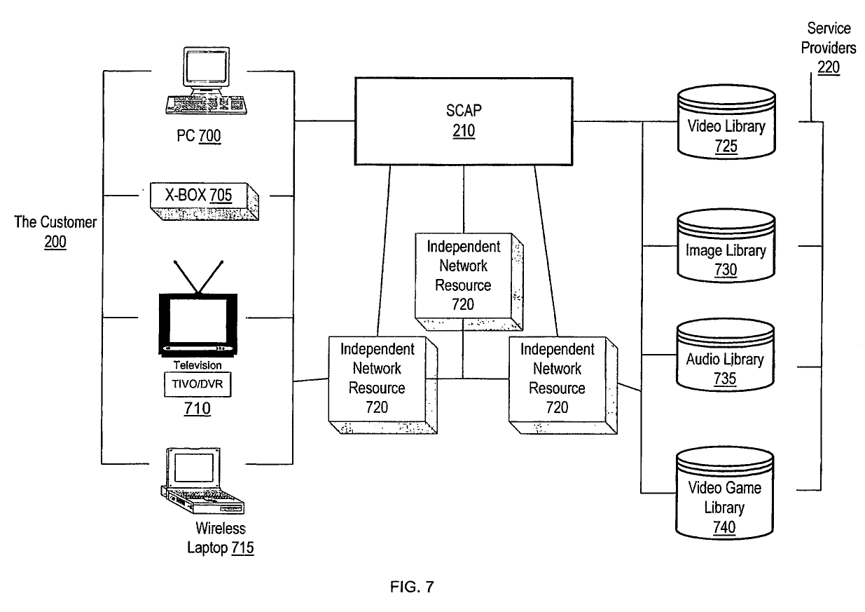

FIG. 7 is a diagram illustrating the relationships between the customer 200, the SCAP 210, and Service Providers (media libraries) 220 involved in a media content provider embodiment of the present invention. The customer 200 in this embodiment may use a desktop personal computer 700, a wireless-networked laptop computer 715, an internet-enabled personal gaming console 705, such as Microsoft's X-Box, the Sony Playstation II and/or the like to connect to both the an independent network resource 720 and the SCAP 210. The customer 200 may also connect to the an independent network resource 720 and the SCAP 210 through a WebTV module connected to a television 710 with a Digital Video Recording Unit (i.e., Tivo, Replay DVR, etc. . . . ). The communications between the customer 200 and the SCAP 210 may be implemented using different terminals including personal computers, televisions, wireless devices, and performed via any number of peripheral devices associated with the connecting devices, such as remote controls, computer mice, or keyboards etc. . . .

In the embodiment illustrated in FIG. 7, SCAP 210 is connected to multiple media content providers, as service providers 220. The SCAP 210, as well as, the media content providers 220 are also connected to independent network resources 720. A video library 725, image library 730, audio library 735, and video game library are illustrated in FIG. 7. The media content libraries discussed above are set forth as examples only. Accordingly, aspects of the invention are not intended to be limited to these particular types of media.

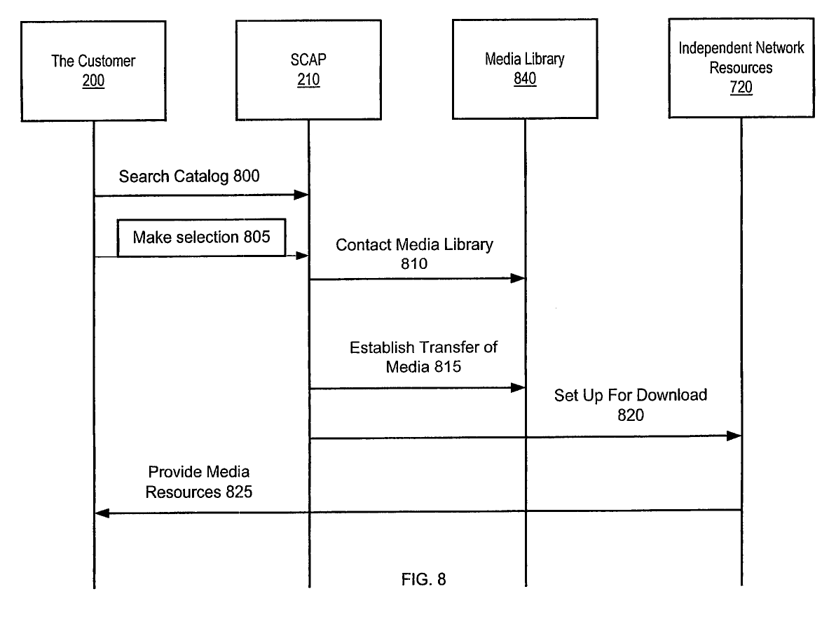

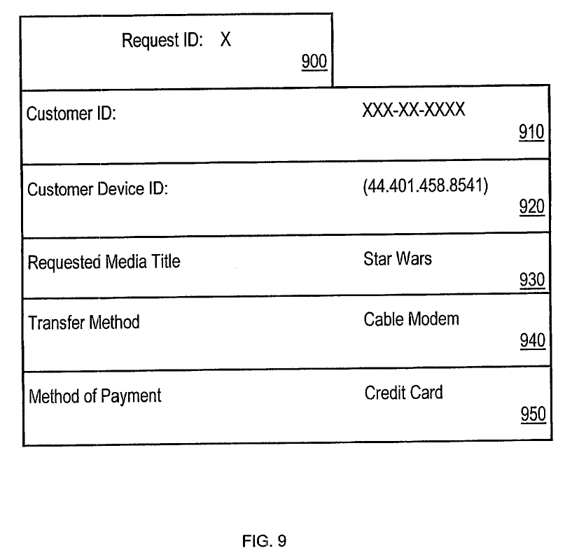

FIG. 8 is an exemplary operation diagram of a media content provider in an embodiment of the present invention. The customer 200 is capable of connecting to SCAP 210. Upon connection the customer 200 may search a catalog of assorted media-content such as movies, television shows, digital music files, digital still images, and video game titles that are available for download in step 800. The customer 200 may make a selection in step 805. The process of making a selection 805 is similar to submitting a request for service discussed in the previous embodiments and will be discussed further in connection with FIG. 9. One additional aspect associated with making a request in this embodiment of the present invention relates to media selection. The SCAP 210 may provide the customer 200 with access to a meta-indexing capability, wherein customer requests are translated to searches in remote or proprietary libraries which are not accessible via the internet. The SCAP 210 acts as a proxy and allows transactions with customers 200, which otherwise may not have access to such systems.

The SCAP 210 contacts the media library 840 in step 810 corresponding to the customer's selection and establishes a method for transfer of the selected media. The customer selection process may involve the customer 200 obtaining access to the media for a single use. Alternately, the use may be similar to a rental, wherein the customer is given access for a predetermined time period. Further, the request may be a purchase of the media. The single-use aspect of the present invention is authenticated and managed by SCAP 210, but appears to be normal to the proprietary media libraries, i.e., a video library may not be accessible to the public but is accessible on a per use basis to SCAP subscribers. The SCAP 210 may incorporate search and DOI technology to allow better identification and selection of media by customers 200 and match such requests to digital content or services available on servers and networks which are connected to the SCAP 210.

After establishing the transfer with the media library 840 in step 815, the SCAP 210 coordinates the download of the selected media to the customer 200 in step 820 by creating a communication path over the independent network resources 720 between the media library 840 and the customer 200. The SCAP 720 enables users to download the selected media request by conducting inquiries and reserving capacity on various networks in order to maintain an acceptable quality of service during the streaming or download of the selected media. The customer 200 is then able to download the selected media over the independent network resources 720 in step 825. This aspect of the present invention is further detailed in an example below. It is to be understood that the independent network resources 720 may be implemented through the use of wired broadband networks, wireless networks such as WiFi, as well as, Ultra-Wideband technologies or any other networking connection that facilitates a customer's access to high speed multimedia or broadband interactions with other users or libraries.

Additionally, the SCAP 210 is capable of coordinating devices to transact between themselves. For example, the SCAP 210 may provide coordinating instruction for a HDTV video conference or alternately coordinating a one-on-one gaming application which may require at least one of the customers to a special network.

For example, if the customer request identifies an MPEG file owned by Disney, the SCAP 210 arranges access to a secure delivery method, while managing payment to the entities involved in the transfer. The SCAP 210 coordinates the download as identified in step 820. Accordingly, the SCAP 210 may coordinate the download request by combining a special request to transfer the file over VyVx network from LA to Washington, through a Level 3 Network from Washington to New York, and finally, through a Starbucks WiFi wireless network connection to the customer who made the original request.

In an additional example of the embodiment illustrated in FIG. 7, the customer device comprises a television 710 with a DVR such as TiVo. The transfer of the selected media may be executed over a broadband or private connection and may be encrypted. For security purposes, SCAP 210 will then forward to the television 710 a public key or other security element to allow the user to start viewing or using the file.

In an alternate embodiment of the present invention the customer's devices may be configured to automatically initiate a media selection. For example, a customer's computer may be configured to subscribe to a movie of the month, top-rated, just released, or a recommended viewing subscription service administered by the SCAP 210. It is to be understood that there are other methods of automatically downloading selected media to a customer's device. Accordingly, The customer's device may automatically download the media without a specific user request.

The media transfer may be executed using TCP/IP based protocols as well as MPLS and NNI signaling to establish preferred routing, thereby enabling the user to download the large file at a relative priority with regard to other traffic on the networks. SCAP 210 will ensure that television 710 has used the file for the intended purpose or time specified in during the media selection step 805.

FIG. 9 is a tabular representation of a selection for media content associated with the embodiment illustrated in FIG. 8. The request ID field 900 is a system defined unique identifier associated with the request, used for internal tracking purposes. The customer ID field 910 is a unique identifier associated with each customer 200. The customer ID 910 may be system defined, a social security number, a credit card number or any other unique identifier useful for identifying the customer 200. The customer ID 910 may link to a customer database 119d as described in relation to FIG. 1 that stores additional information about the customer 200, such as payment information, transaction history with the SCAP 210, etc. The customer device ID field 920 refers to the customer's network connection address. The customer device ID field 920 may be, but is not limited to the customer's IP address or alternately phone number. It is also to be understood that other types of device identification may be used. The SCAP 210 is capable of identifying a user based on the network connection address. Specifically, the process of identifying a user based upon the connection address is accomplished through the implementation of ENUM standards. The requested media title 930 identifies the customer's selected media from the media library catalog. The transfer method field 940 may be discerned from the request address, or it may be an explicit field in the selection process. The transfer method 940 involves identification of the type of network the media transfer will execute on (i.e., dial-up, cable modem, DSL, wireless network). The transfer method 940 is used by the SCAP 210 to optimize the media transfer to the customer. The method of payment 950 specifies how the customer 200 intends to pay for the service rendered. For example, the customer 200 may select to pre-pay, use a credit card, a debit card, bill his/her phone number, have a third party pay, etc. The method of payment 950 may be relevant to determining a price because different payment options may e.g. cost SCAP 210 different amounts to process, only be available for select services, etc.

It should be understood that the above description is only representative of illustrative embodiments. For the convenience of the reader, the above descriptions have focused on a representative sample of all possible embodiments, a sample that teaches the principles of the invention. The description has not attempted to exhaustively enumerate all possible variations. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that the embodiments and variations shown and described herein are merely illustrative of the principles of this invention and that various modifications may be implemented without departing from the scope and spirit of the invention.

We claim:

1. A method for obtaining services comprising:
identifying a need for at least one type of service for use by a customer;
submitting a service request to an acquiring entity for at least one type of service;
receiving a service proposal from the acquiring entity including an estimate for cost of services; and
transmitting an indication to the acquiring entity whether or not the service proposal is acceptable.

2. The method for obtaining services of claim 1 wherein the acquiring entity compares the service request with known service provider parameters to provide service to the customer.

3. The method for obtaining services of claim 1 further comprising:
submitting payment for the services provided.

4. The method for obtaining services of claim 3 further comprising:
receiving the services from the acquiring entity;

5. The method for obtaining services of claim 3 further comprising:
receiving the services from the a service provider independent of the acquiring entity;

6. The method for obtaining services of claim 1 wherein the services comprise telecommunication services.

7. The method for obtaining services of claim 1 wherein the services comprise internet provider services.

8. The method for obtaining services of claim 1 wherein the services comprise media-related services.

9. A method for acquiring services on behalf of a customer comprising:
receiving a service request from a customer, wherein said service request specifies requested services;
comparing the requested services with stored service provider parameters;
preparing a service proposal indicating the result of a service query to at least one service provider, wherein said service proposal comprises a cost estimate;
transmitting the service proposal to the customer; and
establishing a transfer of requested services to the customer in the event of an affirmative response to the service proposal.

10. The method of acquiring services in claim 9 further comprising:
extracting pertinent data from the service request;

11. The method of acquiring services in claim 10 wherein the comparison is executed within an acquiring entity's system.

12. The method of acquiring services in claim 10 wherein the comparison is executed within a system populated with data provided by at least one service provider.

13. The method of acquiring services in claim 10 wherein the requested services are provided through an acquiring entity.

14. The method of acquiring services in claim 10 wherein the requested services are provided by a service provider entity acting in coordination with an acquiring entity.

15. The method of claim 9 wherein said service query comprises:
storing the requested service query in a database;
determining if the requested services are capable of being provided;
wherein said service proposal comprises a designated time for when the services will be provided; and
wherein said service proposal comprises an indication of which services will be provided.

16. A method for acquiring services of claim 10 wherein the services comprise telecommunication services.

17. A method for acquiring services of claim 10 wherein the services comprise internet provider services.

18. A method for acquiring services of claim 10 wherein the services comprise media-related services.

19. A method for acquiring service on behalf of a customer comprising:
providing access to a searchable index of available media services;
receiving a service request from a customer, wherein said service request specifies media-related services;
establishing a transfer of the requested media from a media service provider;
coordinating the transfer over at least one network from the media service provider to the customer.

20. The method of acquiring services of claim 19 further comprising:
enabling the customer to utilize the transferred media.

21. The method of acquiring services of claim 19 further comprising:
providing compensation to entities involved in the media transfer.

22. The method of acquiring services of claim 19 wherein coordinating the transfer maintains a predetermined quality of service level.

23. The method of acquiring services of claim 19 wherein the service request from a customer provides a searchable term.

24. The method of acquiring services of claim 19 wherein the media service provider is not publicly accessible.

25. A method for providing services to a customer comprising:
receiving a service request from an acquiring entity to provide requested services to the customer independent from the acquiring entity;
providing a cost estimate for the requested service to the acquiring entity; and
providing services to the acquiring entity, said acquiring entity transferring services to the customer.

26. A method for providing services of claim 25 wherein the services comprise telecommunication services.

27. A method for providing services of claim 25 wherein the services comprise internet provider services.

28. A method for providing services of claim 25 wherein the services comprise media-related services.

29. A method for providing services to a user entity comprising:
receiving a service request from an acquiring entity to provide requested services to a customer independent from the acquiring entity;
providing a cost estimate for the requested service to the acquiring entity; and
providing requested services to the customer, after receiving service providing instruction from the acquiring entity.

30. A method for providing services of claim 29 wherein the services comprise telecommunication services.

31. A method for providing services of claim 29 wherein the services comprise internet provider services.

32. A method for providing services of claim 29 wherein the services comprise media-related services.

33. A system for obtaining services comprising:
a memory having program code stored therein;
a processor operatively connected to said memory for carrying out instructions in accordance with said stored program code;
wherein said program code, when executed by said processor, causes said processor to:
identify a need for at least one type of service for use by a customer;
submit a service request to an acquiring entity for at least one type of service;
receive a service proposal from the acquiring entity including an estimate for cost of services;
transmit an indication to the acquiring entity whether or not the service proposal is acceptable.

34. The system of claim 33 wherein said program code causes said processor to obtain services wherein the acquiring entity compares the service request with known service provider parameters to provide service to the customer.

35. The system of claim 33 wherein said program code causes said processor to
submit payment for the services provided.

36. The system of claim 35 wherein said program code causes said processor to
receive the services from the acquiring entity;

37. The system of claim 35 wherein said program code causes said processor to:
receive the services from the a service provider independent of the acquiring entity;

38. The system of claim 33 wherein said program code causes said processor to obtain services wherein the services comprise telecommunication services.

39. The system of claim 33 wherein said program code causes said processor to obtain services wherein the services comprise internet provider services.

40. The system of claim 33 wherein said program code causes said processor to obtain services wherein the services comprise media-related services.

41. A system for acquiring services on behalf of a customer comprising:
a memory having program code stored therein;
a processor operatively connected to said memory for carrying out instructions in accordance with said stored program code;
wherein said program code, when executed by said processor, causes said processor to:
receive a service request from a customer, wherein said service request specifies requested services;
compare the requested services with stored service provider parameters;
prepare a service proposal indicating the result of a service query to at least one service provider, wherein said service proposal comprises a cost estimate;
transmit the service proposal to the customer; and
establish a transfer of requested services to the customer in the event of an affirmative response to the service proposal.

42. The system of claim 41 wherein said program code causes said processor to:
extract pertinent data from the service request;

43. The system of claim 42 wherein said program code causes said processor to acquire services wherein the comparison is executed within an acquiring entity's system.

44. The system of claim 42 wherein said program code causes said processor to acquire services wherein the comparison is executed within a system populated with data provided by at least one service provider.

45. The system of claim 42 wherein said program code causes said processor to acquire services wherein the requested services are provided through an acquiring entity.

46. The system of claim 42 wherein said program code causes said processor to acquire services wherein the requested services are provided by a service provider entity acting in coordination with an acquiring entity.

47. The system of claim 41 wherein said program code causes said processor to acquire services wherein said service query comprises:
storing the requested service query in a database;
determining if the requested services are capable of being provided;
wherein said service proposal comprises a designated time for when the services will be provided; and
wherein said service proposal comprises an indication of which services will be provided.

48. The system of claim 42 wherein said program code causes said processor to acquire services wherein the services comprise telecommunication services.

49. The system of claim 42 wherein said program code causes said processor to acquire services wherein the services comprise internet provider services.

50. The system of claim 42 wherein said program code causes said processor to acquire services wherein the services comprise media-related services.

51. A system for acquiring services on behalf of a customer comprising:
a memory having program code stored therein;
a processor operatively connected to said memory for carrying out instructions in accordance with said stored program code;
wherein said program code, when executed by said processor, causes said processor to:
provide access to a searchable index of available media services;
receive a service request from a customer, wherein said service request specifies media-related services;
establish a transfer of the requested media from a media service provider;
coordinate the transfer over at least one network from the media service provider to the customer.

52. The system of claim 51 wherein said program code causes said processor to:
enable the customer to utilize the transferred media.

53. The system of claim 51 wherein said program code causes said processor to:
provide compensation to entities involved in the media transfer.

54. The system of claim 51 wherein said program code causes said processor to acquire services wherein coordinating the transfer maintains a predetermined quality of service level.

55. The system of claim 51 wherein said program code causes said processor to acquire services wherein the service request from a customer provides a searchable term.

56. The system of claim 51 wherein said program code causes said processor to acquire services wherein the media service provider is not publicly accessible.

57. A system for providing services to a customer comprising:
a memory having program code stored therein;
a processor operatively connected to said memory for carrying out instructions in accordance with said stored program code;
wherein said program code, when executed by said processor, causes said processor to:
receive a service request from an acquiring entity to provide requested services to the customer independent from the acquiring entity;
provide a cost estimate for the requested service to the acquiring entity; and
provide services to the acquiring entity, said acquiring entity transferring services to the customer.

58. The system of claim 57 wherein said program code causes said processor to provide services wherein the services comprise telecommunication services.

59. The system of claim 57 wherein said program code causes said processor to provide services wherein the services comprise internet provider services.

60. The system of claim 57 wherein said program code causes said processor to provide services wherein the services comprise media-related services.

61. A system for providing services to a customer comprising:
a memory having program code stored therein;
a processor operatively connected to said memory for carrying out instructions in accordance with said stored program code;
wherein said program code, when executed by said processor, causes said processor to:
receive a service request from an acquiring entity to provide requested services to a customer independent from the acquiring entity;
provide a cost estimate for the requested service to the acquiring entity; and
provide requested services to the customer, after receiving service providing instruction from the acquiring entity.

62. The system of claim 61 wherein said program code causes said processor to provide services wherein the services comprise telecommunication services.

63. The system of claim 61 wherein said program code causes said processor to provide services wherein the services comprise internet provider services.

64. The system of claim 61 wherein said program code causes said processor to provide services wherein the services comprise media-related services.
